(19) United States
(12) Patent Application Publication
(10) Pub. No.: US 2002/0145885 A1
(43) Pub. Date: Oct. 10, 2002

(54) Method of setting adjusting displacement for illuminating field of surgical light

(76) Inventor: Jyh-Wei Liang, Taipei Hsien (TW)

Correspondence Address: BIRCH STEWART KOLASCH & BIRCH, PO BOX 747, FALLS CHURCH, VA, 22040-0747, US

(21) Appl. No.: 09/826,955

(22) Filed: Apr. 6, 2001

(51) Int. Cl. F21S 4/00; F21V 7/00

(52) U.S. Cl. 362/804; 362/296; 362/341; 362/347

(57) ABSTRACT

A method of setting adjusting displacement for surgical light illuminating field comprises the steps of: (a) setting an illumination plane below the surgical light head for a selected distance; (b) setting a first height of the filament such that the light emitting from the filament will be reflected by the reflector of the surgical light and projected onto the illumination plane to form a minimum illuminating field; and (c) setting a second height of the filament to enable light passing over the upper rim of the lamp cup and projecting to the lowest position of the housing of the surgical light head (or between the lowest effective reflection point of the reflector and the lowest position of the housing of the surgical light head). Using the second height of the filament at the step (c) as the lowest point of adjusting displacement thereby enabling the surgical light be adjusted to a maximum illuminating field without reducing the interception and reflection angle of the beam emitting from the light source, and having full utilization of the reflector area.

### FIELD OF THE INVENTION

This invention relates to a method of setting adjusting displacement for illuminating field of surgical light and particularly a method that is capable of maintaining maximum illuminating field of the surgical light without decreasing the light source interception or reflection angle or maintaining full utilization of the reflector surface.

### BACKGROUND OF THE INVENTION

Surgical light is an important facility in the operating theater. In addition to proper light color and intensity, a desirable surgical light should also have the capability of adjusting illuminating field. In a surgery, the operation incision may be very small and needs only the light focusing on a small field. However, the injured area could be relative large in case it is a treatment for a burned or scalded body surface, the illuminating field should be enlarged to cover a relatively bigger area. Thus, to adjust and change the illuminating field is an indispensable function for a surgical light assembly.

FIG. 1A illustrates a conventional surgical light head structure that generally includes a housing P20, a reflector P21 located inside the housing P20, and a transparent shield P22. Between the reflector and transparent shield, there is a reciprocal sliding mechanism (not shown in the drawing) for moving the position of the lamp cup P23 and filament 11 to change the relative position of the filament 11 and reflector thereby to change the focusing distance of the reflected light from the reflector P21. In general, the mechanism has a trapezoidal rod coupled with an outer sleeve. The trapezoidal rod further engages with a handle 10 located below the housing P20. The outer sleeve has a pin engaged with the screw teeth of the trapezoidal rod. When the trapezoidal rod is turned, the pin will lift or lower the sleeve and consequently slide the lamp cup P23 upwards or downwards. When in use, turning the handle 10 will also turn the trapezoidal rod and consequently slide the lamp cup P23 and filament 11 up or down. Through the upward or downward movement, the focal distance will also change along the variation of the upward and downward displacement. As a result, different sizes of illuminating field will be formed at the same projecting plane y-y′.

The surgical light head should be properly designed to prevent the emitting light of the filament 11 from directly projecting to the eyes of the surgical team; otherwise it could decrease their visual sensitivity. Hence the lamp cup P23 should be maintained at a proper height for obstructing light from directly emitting out of the housing P20.

The setting of adjusting displacement for illuminating field of surgical light should be based on commonly used illuminating distance during operation. It usually is done by presetting an illumination plane, and based on the variation of illuminating field on the plane to determine the adjusting displacement of the lamp cup P23 or filament 11 (note: the illumination distance means the distance between the plane x-x′ at the lower rim of the housing P20 and the illumination plane y-y′. It may be in the range between 0.8 meter to 1.3 meters, or taking one meter as the basis).

The setting of corresponding relation between the filament 11 and illuminating field for the surgical light now available on the market or known is illustrated in FIGS. 1A and 1B. When the filament 11 is at the lowest point of the adjusting displacement, light focus on the illumination plane y-y′ and form thereon the highest light intensity and smallest illuminating field. Referring to FIGS. 2A and 2B, when the filament 11 is moved upwards, the focusing distance is moved away from the illumination plane y-y′, as a result, the illuminating field is proportionally enlarged with the changing focusing distance.

Also shown in FIG. 1A, when the filament 11 is at the lowest point of the adjusting displacement, light beam pass over the upper rim of the lamp cup P23 and project on the lowest effective reflection point b of the reflector P21. Referring to FIG. 2B, when the filament 11 is moved upward on the displacement mechanism, the illuminating field at the plane y-y′ is enlarged but light intensity is decreasing and the light passing over the upper rim of the lamp cup P23 is moved from the lowest effective reflection point b to a relative higher point b′. As a result, the angle of the light beam intercepted by the reflector decreases (the lower portion of the reflector has no effect). It thus may be seen that for the presently marketed or known surgical light, when the illuminating field is expanded, not only light intensity within the illuminating field decreases but also the angle of the beam emitting from the light source and intercepted by the reflector reduces (or the effective area of the reflector becomes smaller).

In other words, for the presently marketed or known surgical lights, when the illuminating field is expanding, light intensity will continuously decrease and the interception and reflection angle of the beam emitting from the light source (or reflector effective area) will be continuously reduced. It becomes a double discounting to the light intensity. This is a long existing shortcoming for the presently marketed or known surgical lights and it still begs for improvement.

### SUMMARY OF THE INVENTION

In view of aforesaid disadvantages, it is therefore an object of this invention to provide a method of setting adjusting displacement for surgical light illuminating field, which is capable of keeping the interception and reflection angle of the beam emitting from the light source from reducing or is capable of achieving full utilization of the reflector surface while maintaining the illuminating field at the maximum, thereby to prevent the concurrent happening of light intensity decreasing and light interception and reflection angle reducing (or diminishing of reflector functional area).

To attain the foregoing object, this invention takes the following steps to set the adjusting displacement of the lamp cup and filament:

(a) setting an illumination plane below the surgical light head for a selected distance;

(b) setting the first height of the filament such that light of the filament reflected from the reflector will project on the plane with the smallest illuminating field; and

(c) setting a second height of the filament such that light passing over the upper rim of the lamp cup projects on light head housing at the lowest position.

The position of the step (c) is set as the lowest point of the adjusting displacement for the surgical light whereby when the illuminating field is adjusted to maximum, the interception and reflection angle of the beam emitting from light source won't decrease and the reflector surface will be fully utilized.

### BRIEF DESCRIPTION OF THE DRAWINGS

The invention, as well as its many advantages, may be further understood by the following detailed description and drawings, in which:

FIG. 1A is a schematic view of a conventional structure of surgical light head and light path of the incident light for the reflector, showing the filament center is at the lowest position of adjusting displacement.

FIG. 1B is a schematic view of a conventional structure of surgical light head and light path of the incident light for the reflector, showing the filament center is at the highest position of adjusting displacement.

FIG. 2A is a schematic view of the reflection light path and illuminating field diameter at a standard projection distance when the filament center is at the lowest position of the adjusting displacement, according to conventional technique.

FIG. 2B is a schematic view of the reflection light path and illuminating field diameter at a standard projection distance when the filament center is at the highest position of the adjusting displacement, according to conventional technique.

FIG. 3A is a schematic view of the surgical lamp structure and light path of incident light for the reflector according to this invention, showing the filament center is at the first height position of the filament of the adjusting displacement.

FIG. 3B is a schematic view of the surgical lamp structure and light path of incident light for the reflector according to this invention, showing the filament center is at the second height position of the filament of the adjusting displacement.

FIG. 4A is a schematic view according to this invention showing the reflection light path and illuminating field diameter at a standard projection distance when the filament center is at the first height position of the filament.

FIG. 4B is a schematic view according to this invention showing the reflection light path and illuminating field diameter at a standard projection distance when the filament center is at the second height position of the filament.

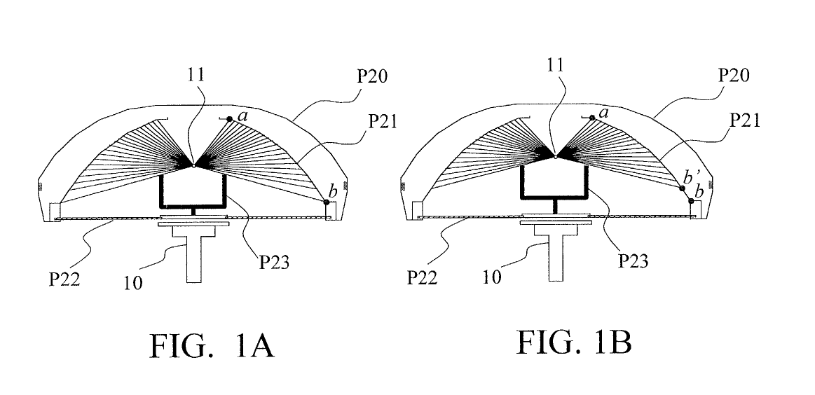

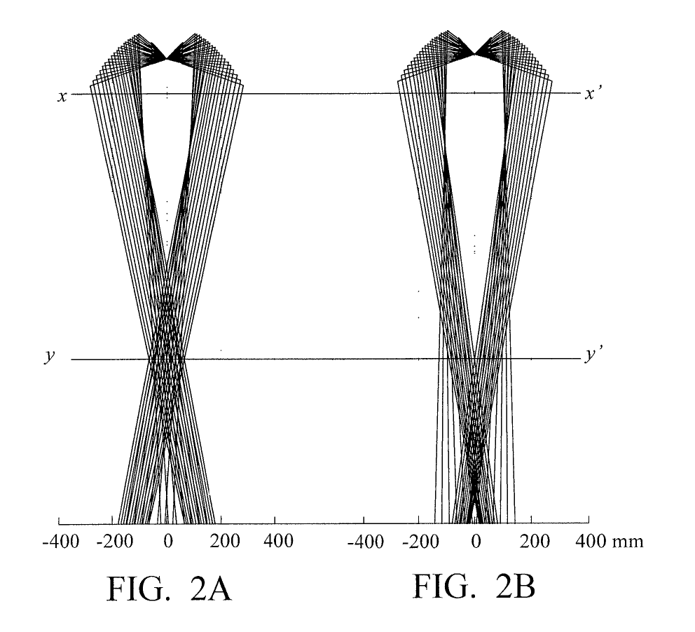

### DESCRIPTION OF THE PREFERRED EMBODIMENT

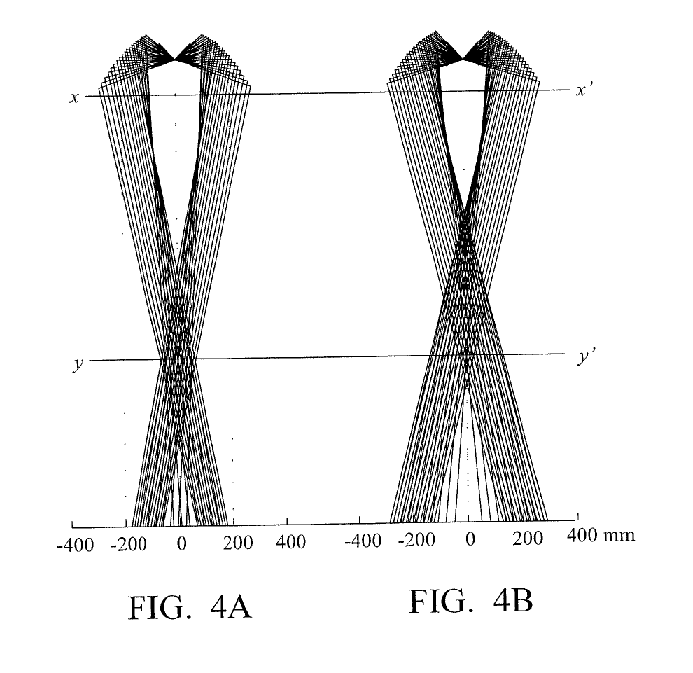

Referring to FIGS. 4A and 4B, this invention employs the following steps to set the adjusting displacement for the lamp cup P23 and filament 11:

(a) setting an illumination plane y-y′ below the lower rim of the housing of the surgical light head at a distance of one meter;

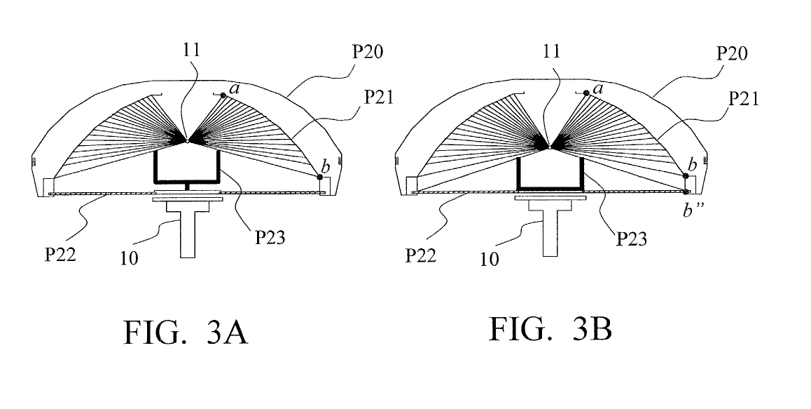

(b) setting a first height of the filament (referring to FIG. 3A) such that the light emitting from the filament 11 will be projected onto the reflector of the surgical light and reflected onto the illumination plane to form a minimum illuminating field as shown in FIG. 4A; and

(c) setting a second height of the filament (referring to FIG. 3B) and moving the filament 11 downwards to enable light projecting to the lowest position b″ on the housing of surgical light head (or between the lowest effective reflection point and the lowest position b″).

By means of the procedures set forth above to determine the lowest point of the adjusting displacement of the surgical light, thereby when the illuminating field of the surgical light is adjusted to the maximum, the reflector area will be fully utilized and the angle of the beam emitting from light source and intercepted by the reflector do not decrease.

In other words, the adjustment direction for increasing illuminating field is opposite to that of the conventional surgical lights. Known conventional surgical lights have to move the filament 11 upwards for increasing the illuminating field, but due to the hindrance caused by lamp cup P23, the upward movement will result in the lower portion of the reflector P21 not able to receive light emitting from the light source and to reflect the light to the illumination plane y-y′, consequently decrease the illuminating intensity.

This invention takes the opposite approach. When the filament 11 is moved downwards for enlarging the illuminating field, the lamp cup P23 will not obstruct any portion of the light that is emitting from the filament 11 and can be intercepted by the reflector P21. Hence after adapting the setting method of this invention, the reflector P21 can fully receive the light from the filament (light source interception and reflection angle do not decrease) and reflect the light to the illumination plane y-y′ without any compromise on light interception angle even in the condition of the largest illuminating field. It thus may achieve a better result than that of the known surgical lights.

It is to be noted that the distance, or the focusing distance, to the illumination plane y-y′ according to this invention is not limited to one meter below the plane x-x′ at the lower rim of surgical light head housing P20. The upward movement of the filament may extend the focusing distance. When surgical team needs more space for operation (such as to perform orthopedic surgery), the distance between the surgical light head and illuminating field may be extended so that light may focus at a longer distance (such as 1.4 meters below the surgical light head) to form an appropriate illuminating field with adequate lighting intensity.

It may thus be seen that the objects of the present invention set forth herein, as well as those made apparent from the foregoing description, are efficiently attained. While the preferred embodiment of the invention has been set forth for purpose of disclosure, modifications of the disclosed embodiments of the invention as well as other embodiments thereof may occur to those skilled in the art. Accordingly, the appended claims are intended to cover all embodiments that do not depart from the spirit and field of the invention.

What is claimed is:

1. A method of setting adjusting displacement for surgical light illuminating field, comprising the steps of:
a. setting an illumination plane below a surgical light head for a selected distance;
b. setting a first height of the filament such that light emitting from the filament will reflect to the reflector of the surgical light and focus on the illumination plane to form a minimum illuminating field; and
c. setting a second height of the filament and moving the filament downwards to enable light projecting to a position between the lowest position of the surgical light head housing and the lowest effective reflection point of the reflector; and
d. using the second height of the filament at the step c as the lowest point of filament adjusting displacement thereby enabling the surgical light be adjusted to a maximum illuminating field without reducing the interception and reflection angle of the beam emitting from the light source, and having full utilization of the reflector area.

2. The method of claim 1, wherein the selected distance at the step a is between 0.8 meter and 1.3 meters.

3. The method of claim 2, wherein the selected distance is one meter.

4. The method of claim 1, wherein at the step c the filament is moved downwards to a position such that the light projecting to the lowest effective reflection point of the reflector of the surgical light.

5. The method of claim 1, wherein at the step c the filament is moved downwards to a position such that the light projecting to the lowest position of the housing of the surgical light.

6. The method of claim 1, wherein the distance between the first height and second height of the filament is at least from 20% to 100% of the total filament adjusting displacement.

7. The method of claim 1, wherein the distance between the first height and second height of the filament is at least from 50% to 100% of the total filament adjusting displacement.

8. The method of claim 1, wherein the distance between the first height and second height of the filament is equal to the total filament adjusting displacement.

9. The method of claim 1, wherein the filament is movable upwards above the first height of the filament.

10. The method of claim 9, wherein light emitting from the filament is reflected by the reflector of the surgical light and focused below the illumination plane.

11. The method of claim 10, wherein the focused distance is between one meter and 1.4 meters below the surgical light head.
